(19) United States
(12) Patent Application Publication
(10) Pub. No.: US 2002/0088153 A1
(43) Pub. Date: Jul. 11, 2002

(54) Interchangeable identification devices on medical containers

(76) Inventor: Eliezel Torres, Hamburg, NJ (US)

Correspondence Address: Mr. Walter J. Tencza Jr., Suite 3, 10 Station Place, Metuchen, NJ, 08840, US

(21) Appl. No.: 09/757,145

(22) Filed: Jan. 9, 2001

(51) Int. Cl. G09F 3/10

(52) U.S. Cl. 40/299.01

(57) ABSTRACT

A manner of labeling devices, particularly pipettes, which include medical materials, is disclosed. In one embodiment an apparatus comprising a first device capable of dispensing a medical material and a removable identification plate which indicates the type of medical material capable of being dispensed is disclosed. The removable identification plate can be attached to the first device and can be detached from the first device. The removable identification plate may be color coated and the color coating may indicate the type of medical material in the first device. The device containing medical material may have a first gap and a second gap. The removable identification plate may have a first portion which can be inserted into the first gap and a second portion which can be inserted into the second gap in order to attach the removable identification plate to the first device. The removable identification plate may for example indicate that the material in the first device is radioactive, comprised of DNA, comprised of RNA, or is biological. Also disclosed is a method comprised of providing a plurality of identification plates wherein each identification plate specifies a type of medical material. The method further comprises attaching a first identification plate of the plurality of identification plates to a first device which is able to dispense medical material of the type specified by the first identification plate. In another embodiment a removable sleeve can be placed on a pipette device to indicate the type of medical material to be dispensed.

### FIELD OF THE INVENTION

This invention relates to improved methods and apparatus for identifying fluids or materials particularly those used for medicinal purposes.

### BACKGROUND OF THE INVENTION

Typically medical devices which include medical material such as pipettes, are labeled with tape. A doctor may write on the tape to indicate what kind of medical material is in the device. This is not adequate, since often the doctor's handwriting is not understandable and also the tape may fall off the medical device.

### SUMMARY OF THE INVENTION

The present invention in various embodiments provides a manner of labeling devices including medical materials in them, particularly pipettes. In one embodiment an apparatus comprising a device containing medical material; and a removable identification device such as an identification plate which indicates the type of medical material in the device is disclosed. The removable identification plate can be attached to the device containing medical material and can be detached from the device containing medical material The device containing medical material may be a pipette.

The removable identification plate may be color coated or may have a name imprinted thereon and the color coating may indicate the type of medical material in the device containing medial material. The device containing medical material may have a first gap and a second gap. The removable identification plate may have a first portion which can be inserted into the first gap and a second portion which can be inserted into the second gap in order to attach the removable identification plate to the device containing medical material.

The removable identification plate may for example indicate that the material in the device containing medical material is radioactive, comprised of DNA, comprised of RNA, or is biological.

In another embodiment a removable sleeve can be placed on a pipette device to indicate the type of medical material to be dispensed.

The present invention, in various embodiments also discloses a method comprised of providing a plurality of identification plates wherein each identification plate specifies a type of medical material. The method further comprises attaching a first identification plate of the plurality of identification plates on a device which contains medical material of the type specified by the first identification plate.

In the present application “plate” is used in a broad sense to include curved plates or a plate including extension portions for attaching to a device having medical material.

### BRIEF DESCRIPTION OF THE DRAWINGS

FIG. 1 shows a left side planar view of a pipette device with an interchangeable identification plate in accordance with an embodiment of the present invention;

FIG. 2 shows a right side planar view of the pipette device of FIG. 1 partially taken apart;

FIG. 3 shows a top cross sectional view of the pipette device of FIG. 1;

FIG. 4 shows a side view of a sleeve shown in dashed lines on a portion of a pipette device in accordance with another embodiment of the present invention;

FIG. 5 shows a cross sectional view of the sleeve of FIG. 4; and

FIG. 6 shows a side view of the sleeve of FIG. 4 off of the pipette device.

### DETAILED DESCRIPTION OF THE DRAWINGS

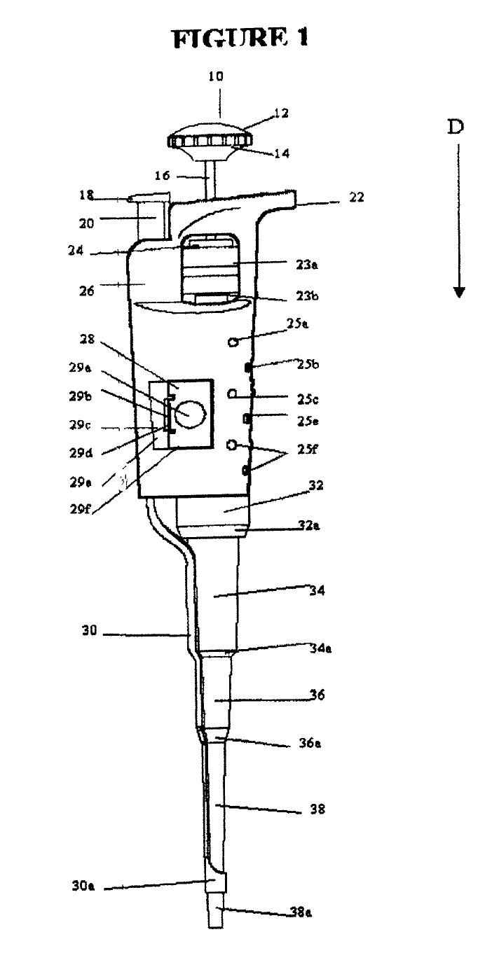

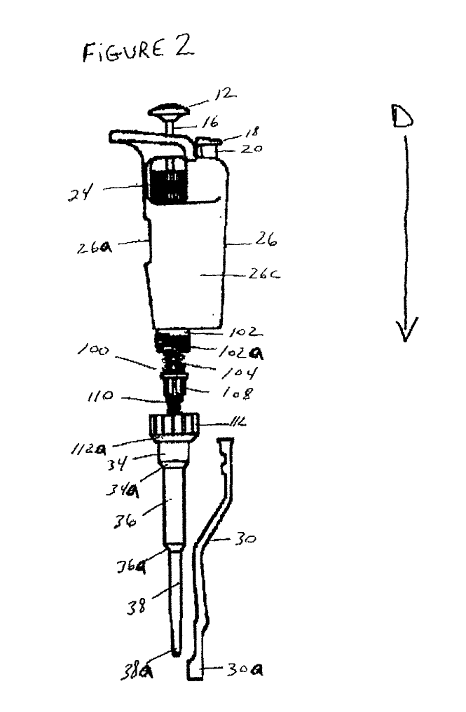

FIG. 1 shows a front planar view of a pipette device 10 which includes an interchangeable identification plate 28 in accordance with an embodiment of the present invention. The pipette device 10 includes thumb button 12, plunger 16, ejector button 18, ejector button 20, protrusion portion 22, body 23a, volume adjuster knob portion 23a, a volume adjuster screw 23b, volume adjuster knob portion 24, pipette body 26, attached removable plate 28, an ejector shaft 30, a screw on collar 32, a shaft 34, a shaft 36, and a shaft 38. The shafts 34, 36, and 38 may actually be integrated into one piece. As shown in FIG. 2 shaft 34 have narrowing portion 34a which connects to shaft 36. Shaft 36 may have narrowing portion 36a which connects to shaft 38 and shaft 38 may have narrowing portion 38a. FIG. 2 also shows the tip 30a of the ejector 30.

The pipette body 26 includes non-slip grip bumps 25a, 25b, 25c, 25d, 25e, and 25f. The removable plate 28 includes portions 29a, 29b, 29c, 29d, and 29e. Portion 29a which is shown as a circular portion is an area which may be embossed for displaying identification words, symbols, acronyms, or phrases. For example, the portion 29a may display the following possible symbols (1) “radioactive”, (2) “PCR” which means Polymerase Chain Reaction, (3) “DNA”, i.e. to stand for deoxyribonucleic acid, (4) “RNA”, i.e. to stand for ribonucleic acid, (5) “Biological” or (6) a matching body color plate which may match the original body plate. The symbol, acronym, word, or phrase on portion 29a identifies the contents in the pipette 10.

The removable plate 28 also includes a portion 29b, a gap 29c, a portion 29d, a gap 29e, and a portion 29f. Portion 29d is a snap portion to help snap the removable plate 28 onto the pipette device 10. Portion 29f is the is a bottom edge of the removable plate 28.

FIG. 2 shows a right side planar view of the pipette device 10 of FIG. 1 partially taken apart. The pipette device 10 includes a piston assembly 100 shown in FIG. 2. The piston assembly 100 includes a body 102 which has outside threading 102a. The piston assembly 100 includes a piston 104, a spring 106, a collar 108, and a spring 110. Also shown in FIG. 2 is a collar 112. The collar 112 has an edge or narrowing portion 112a which gradually decreases in outer diameter going down in the direction D.

The collar 32 shown in FIG. 1 has been taken off and is not shown in FIG. 2. The ejector 30 shown in FIG. 1 is shown separated from the shaft 36 in FIG. 2. The collar 32 can be screwed onto the outer threads 102a of the body 102 shown in FIG. 2 in order to bring the shaft 34 closer to the pipette body and to provide a vacuum seal for the pipette 10. The collar 32 also attaches the ejector 30 to the shaft 36. The ejector 30 is held up to the back of the pipette body 26. The collar 32 has a decreasing portion 32a.

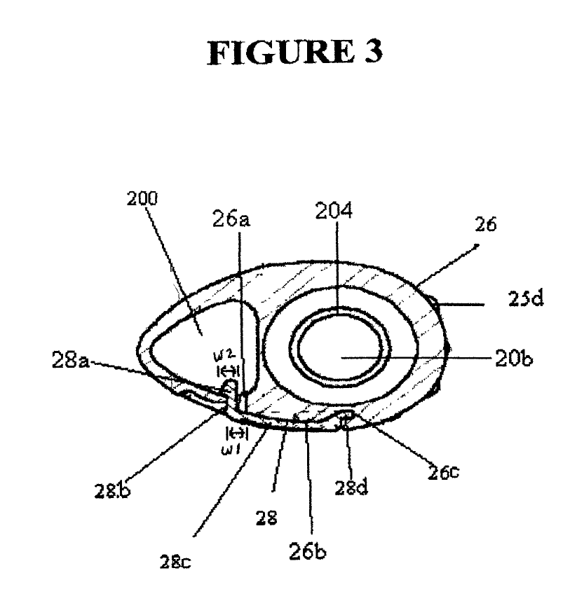

FIG. 3 shows a cross sectional view of the pipette device 10 of FIG. 1 along the line A-B shown in FIG. 1. FIG. 3 shows the location of the ejector chamber 200, chamber for plunger 202, button top 204, and button top 206 of the button 12 shown in FIGS. 1 and 2. The identification plate 28 shown in cross section in FIG. 3 includes portions 28a, 28b, 28c, and 28d. Portion 28a is a triangular portion which when inserted or snapped through a gap 26a of pipette body 26 into ejector chamber 200 holds the identification plate 28 to the pipette body 26 at one end of the identification plate 28. The gap 26a may have a width of W1 which should be greater than the width W2 of the triangular portion 28a to allow insertion. Portion 28b is a flat extension connected to portion 28a. Portion 28c is a curved portion connected to portion 28c which fits the curve or contour of portion 26b of the pipette body 26. Portion 28d is an extension which fits into a portion 26c of the pipette body 26 and which thus holds the other end of the identification plate 28 to the pipette body 26.

Referring to FIG. 1, the thumb button 12 is connected to the plunger 16 which is connected to the portion 23a. The portion 23a is connected to the volume adjuster knob 24. The volume adjuster knob 24 is connected to the portion 23b. The portion 23b comes out of the bottom of the pipette body 26 as piston 104 shown in FIG. 2. The piston 104 proceeds through spring 106, collar 108, spring 110, shaft coupling 112 shown in FIG. 1 and collar 32 shown in FIG. 1. The piston 104 then comes out of shaft 36 as shaft 38 shown in FIG. 2. Liquid can be dispensed through end 38a of the shaft 38. End 38a is typically connected to a pipette tip which may supply aspirated fluids to a test tube or vial for research purposes. Also shown in FIG. 1 is portion 14 of thumb button 12.

The volume adjuster knob 24 controls the amount of fluid which will be supplied to a vial when the thumb button 12 is pressed downwards in a direction D.

The plate 28 can be held to the pipette body 26 in a variety of different manners. A plurality of plates similar to plate 28 can be provided with each having a different color for a different types of fluids or materials. For example “DNA” material may be labeled with the word “DNA” and may also have a color coating of blue on the plate 28, while “Radioactive” material may be labeled with the word “Radioactive” and have a color coating of red on the plate 28.

The identification plate 28 may be made of plastic, metal, rubber, or any other suitable material.

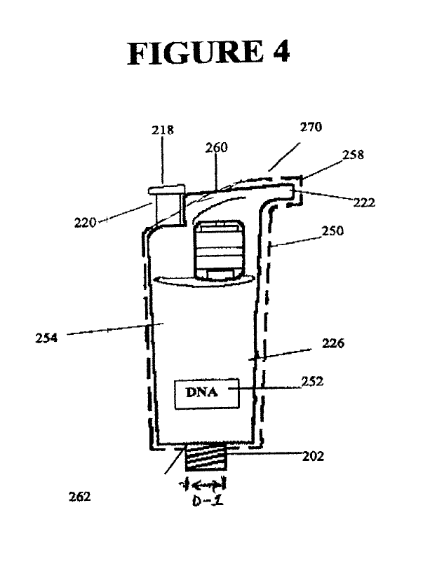

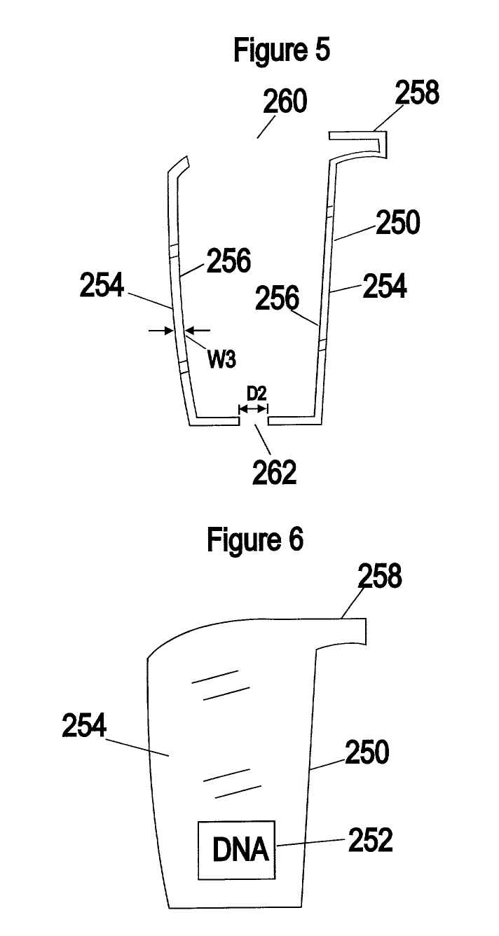

FIG. 4 shows a side view of a sleeve 250 on a portion 270 of a pipette device in accordance with another embodiment of the present invention. The sleeve 250 is shown in dashed lines. The portion 270 of the pipette device includes a body 226, ejector button portion 218, ejector button portion 220, and protrusion portion 222, which correspond to body 26, button 18, button 20, and protrusion 22 of the FIG. 1 embodiment. The pipette portion 270 includes a body 202 which is similar to body 102 in FIG. 1. FIG. 5 shows a cross sectional view of the sleeve 250 of FIG. 4 and FIG. 6 shows a front view of the sleeve 250 of FIG. 4 off of the portion of the pipette device.

The sleeve 250 includes an opening 260 at the top and an opening 262 at the bottom as shown by FIG. 5 and FIG. 4. The sleeve 250 includes an outer surface 254 and an inner surface 256 shown in FIG. 5, and the sleeve 250 has a thickness or width W3 between outer surface 254 and inner surface 256 which may be one eighth (⅛^{th}) of an inch. The sleeve 250 includes a protrusion portion 258 for slipping over the protrusion portion 222 of the pipette body 226. The sleeve 250 includes a label 252 which says “DNA” to indicate the contents of a pipette device which may be similar to the pipette device 10 of FIG. 1, except that the identification plate 28 is not necessary since the sleeve 250 provides identification of the contents of the pipette device.

In operation a user may take apart a pipette device, similar to pipette device 10 in FIG. 1 so that the pipette portion 270 in FIG. 4 is isolated. The user may then insert the body 202 at the bottom of the pipette portion 270 into the opening 260 at the top of the sleeve 250. The user may then pull the sleeve 250 up on to the pipette portion 270 until it is in a position shown in FIG. 4. The protrusion portion 258 of the sleeve 250 can be fitted over the protrusion portion 222 of the pipette portion 270. The body 202 is inserted through the opening 262. The opening 262 may be circular and may have a diameter D2 which should be about the same as the circular diameter D1 of the body 202 so that the body 202 snugly fits in the opening 262. The sleeve 250 may be transparent.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first device able to dispense medical material;
a removable identification plate which indicates the type of medical material that the first device will be dispensing;
wherein the removable identification plate can be attached to the first device and can be detached from the first device.

2. The apparatus of claim 1 wherein
the first device is a pipette.

3. The apparatus of claim 1 wherein
the removable identification plate is color coated and the color coating indicates the type of medical material to be dispensed by the first device.

4. The apparatus of claim 1 wherein
the removable identification plate has writing which indicates the type of medical material to be dispensed by the first device.

5. The apparatus of claim 1 wherein
the first device has a first gap and a second gap;
the removable identification plate has a first portion which can be inserted into the first gap and a second portion which can be inserted into the second gap in order to attach the removable identification plate to the first device.

6. The apparatus of claim 2 wherein
the pipette has a first gap and a second gap; and
the removable identification plate has a first portion which can be inserted into the first gap and a second portion which can be inserted into the second gap in order to attach the removable identification plate to the pipette.

7. The apparatus of claim 1 wherein
the removable identification plate indicates that the material to be dispensed by the first device is radioactive.

8. The apparatus of claim 1 wherein
the removable identification plate indicates that the material to be dispensed by the first device is DNA.

9. The apparatus of claim 1 wherein
the removable identification plate indicates that the material to be dispensed by the first device is RNA.

10. The apparatus of claim 1 wherein
the removable identification plate indicates that the material to be dispensed by the first device is Biological.

11. The apparatus of claim 1 wherein
the first device has a body which has a first color;
wherein the removable identification plate has a second color;
and wherein the first and second colors are the same.

12. A method comprised of
providing a plurality of identification plates wherein each identification plate specifies a type of medical material to be dispensed; and
attaching a first identification plate of the plurality of identification plates on a first device which is able to dispense medical material of the type specified by the first identification plate.

13. The method of claim 12
wherein each of the plurality of identification plates has a color coating and the color coating signifies a medical material of a particular type.

14. The method of claim 12
wherein each of the plurality of identification plates has written material on it and the written material signifies a medical material of a particular type.

15. The method of claim 12
wherein the first device is a pipette.

16. The method of claim 12
wherein the first identification plate, includes a first and a second portion;
wherein the first device includes a first and a second gap;
and wherein the first identification plate is attached to the first device by inserting the first portion into the first gap and inserting the second portion into the second gap.

17. An apparatus comprising:
a removable sleeve which indicates the type of medical material that a first device will be dispensing;
wherein the removable sleeve can be attached to the first device and can be detached from the first device.

18. The apparatus of claim 17 wherein
the removable sleeve is substantially transparent.

19. The apparatus of claim 18 further comprising
the first device.

20. The apparatus of claim 19 wherein
the first device is a pipette device.
